(19) United States
(12) Patent Application Publication
(10) Pub. No.: US 2003/0177586 A1
(43) Pub. Date: Sep. 25, 2003

(54) Tool for compressing a cable connector

(76) Inventor: C. J. Chen, Taipei Hsien (TW)

Correspondence Address: BIRCH STEWART KOLASCH & BIRCH, PO BOX 747, FALLS CHURCH, VA, 22040-0747, US

(21) Appl. No.: 10/099,939

(22) Filed: Mar. 19, 2002

(51) Int. Cl. B25F 1/00

(52) U.S. Cl. 7/107

(57) ABSTRACT

A combination cable connector compression tool for fastening a coaxial cable to a cable connector can also perform stripping, cutting and compression functions. The invention includes a pliers body and a pliers stem movably and pivotally engaging with the pliers body. The pliers stem may be located at a first position spaced a selected distance from the pliers body and a second position close to the pliers body. In the moving displacement, the pliers stem drives and moves a compression head to perform compression operations. There is a cutting section and a stripping section located at corresponding locations of the pliers body and pliers stem. The pliers stem clamps the coaxial cable on the stripping section to perform stripping operations at the first position, and holds the coaxial cable on the cutting section to perform cutting operations at the second position. All of the required operations for fastening the coaxial cable to the cable connector can be performed by the tool of the invention.

### FIELD OF THE INVENTION

The invention generally relates to a tool for compressing a cable connector, and particularly to a combination tool for fastening a coaxial cable to a cable connector, and also for performing stripping, cutting and compressing operations.

### BACKGROUND OF THE INVENTION

Coaxial cables are widely used in signal transmission for devices such as cable TVs. In order to connect the coaxial cable to such equipment, one end of the coaxial cable usually connects to a cable connector. In the past, a cable connector generally included a metal sleeve and a wire clipping ring. After its outer insulation layer has been stripped, the coaxial cable is inserted into the metal sleeve and clamped by the wire clipping ring to form a secure connection with the cable connector. At present, there is another type of cable connector (referring to U.S. Pat. No. 5,941,120, FIGS. 1 and 2). It includes a metal sleeve and a packing ring. The coaxial cable is inserted into the metal sleeve, then the packing ring is thrust into the metal sleeve to form a secured connection between the coaxial cable and the cable connector. U.S. Pat. No. 5,941,120 discloses a special tool for inserting the packing ring into the metal sleeve.

Procedures for fastening the coaxial cable to the cable connector generally include the following:

First, as a general coaxial cable consists of, from the exterior to the interior, an outer insulation layer, a metal mesh, an inner insulation duct and a center conductive wire. The coaxial cable must be cut to a required length before fastening. Then the outer insulation layer and inner insulation duct are stripped to bare the center conductive wire and metal meshes. U.S. Pat. No. 5,829,322 discloses a special tool for stripping the outer insulation layer and inner insulation duct of coaxial cables. In order to simultaneously strip the outer insulation layer and inner insulation duct, the device has two spaced cutters with different elevations. The lower cutter can completely remove the outer insulation layer, metal meshes and inner insulation duct. The higher cutter can remove only the outer insulation layer. When the outer insulation layer and inner insulation duct have been stripped, the bared conductive wire should be cut to a required length. U.S. Pat. No. 5,829,322 also includes a way to perform this function.

After the aforesaid operations have been finished, couple the cable connector with the coaxial cable that has the outer insulation layer and inner insulation duct stripped, and place the cable connector (metal sleeve and packing ring) and coaxial cable together in a special tool disclosed in U.S. Pat. No. 5,941,120 for compressing the coaxial cable in the metal sleeve to fasten the cable connector and coaxial cable.

The fastening operations set forth above require many special tools. They create a lot of operational problems. As the cable connector shown in FIGS. 1 and 2 of U.S. Pat. No. 5,941,120 has gradually replaced conventional cable connectors that use wire clipping rings, the special compression tool disclosed in U.S. Pat. No. 5,941,120 must be used for fastening. However, U.S. Pat. No. 5,941,120 only provides a compression function, thus it cannot fully meet operation requirements.

### SUMMARY OF THE INVENTION

The primary object of the invention is to provide a combination cable connector compression tool that can perform stripping, cutting and compression functions.

The combination cable connector compression tool according to the invention includes a pliers body, a pliers stem, a compression head, a stripping cutter seat, a sever cutter seat and an elastic element. The pliers stem is movably and pivotally engaged with one side of the pliers body, and may be spaced from the pliers body at a selected distance in a first position, and be moved and closed to the pliers body in a second position. The elastic element keeps the pliers stem at the first position in normal conditions. When the pliers stem is moved from the first position to the second position, the pliers stem also moves the compression head to perform compression operations. The pliers stem has a cable coupling section and a cutter blade corresponding to the stripping cutter seat and sever cutter seat of the pliers body to form a stripping section and a cutting section. The pliers stem can clamp the coaxial cable and perform stripping operations at the first position. The pliers stem can also move the coaxial cable to the sever section to perform cutting operations at the second position. Thus the invention can provide all required operations to fasten the coaxial cable to the cable connector.

The foregoing, as well as additional objects, features and advantages of the invention will be more readily apparent from the following detailed description, which proceeds with reference to the accompanying drawings. The drawings are only to serve for reference and illustrative purposes, and are not intended to limit the scope of the invention.

### BRIEF DESCRIPTION OF THE DRAWINGS

FIG. 1 is an exploded view of the invention.

FIG. 2 is a perspective view of the invention.

FIG. 3 is a fragmentary schematic view of the invention.

FIG. 4 is a sectional view of the invention.

FIG. 5 is another sectional view of the invention.

FIGS. 6A, 6B and 6C are fragmentary views of the invention, showing structural relationships.

### DESCRIPTION OF THE PREFERRED EMBODIMENT

The invention aims at providing a tool for compressing a cable connector, assembling and fastening a coaxial cable to the cable connector, and providing cutting, stripping, and compressing operations. A general coaxial cable consists of, from the exterior to the interior, an outer insulation layer, a metal mesh, an inner insulation duct and a center conductive wire. The cable connector includes a metal sleeve and a packing ring. Cutting operations include cutting off the coaxial cable and the center conductive wire to a selected length. Stripping operations include simultaneously stripping the outer insulation layer and inner insulation duct, and baring the center conductive wire and metal mesh in a stepwise manner. Compression operations include coupling the coaxial cable in the cable connector, and thrusting the packing ring into the metal sleeve to fasten the coaxial cable to the cable connector.

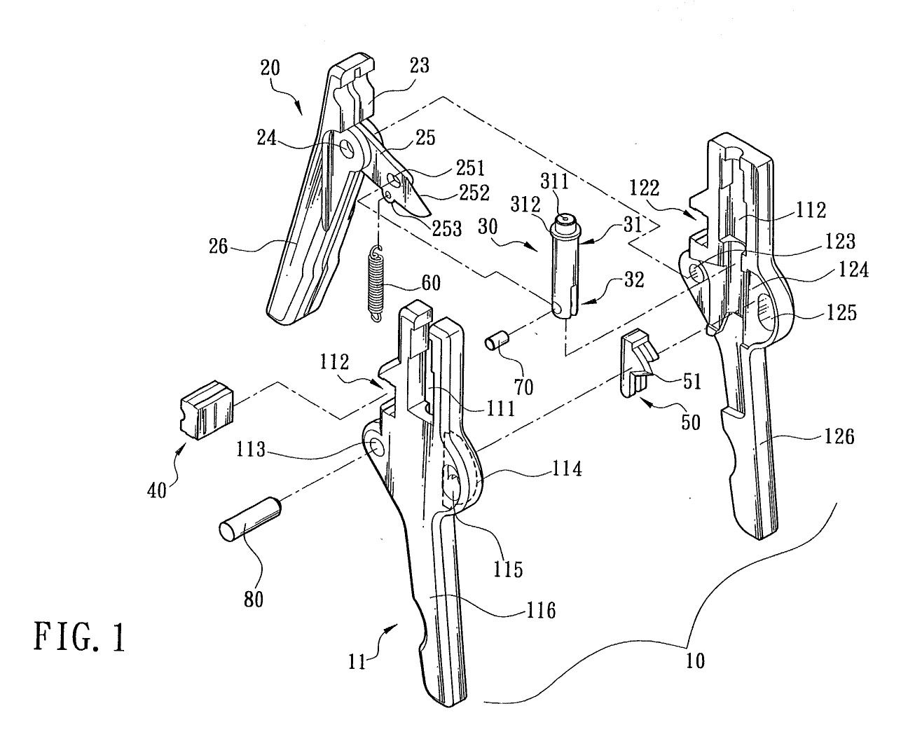

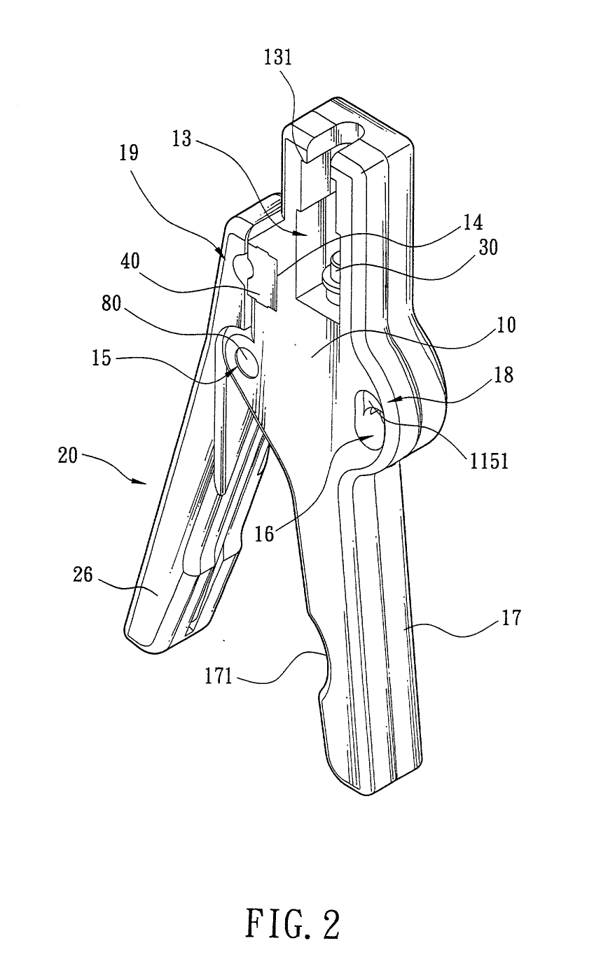

Referring to FIGS. 1 and 2, the tool for compressing a cable connector according to the invention consists of a pliers body 10, a pliers stem 20, a compression head 30, a stripping cutter seat 40, a sever cutter seat 50 and an elastic element 60.

The pliers body 10 includes an upper pliers body 11 and a lower pliers body 12. The upper pliers body 11 has a through first trough 111 formed on an upper section thereof. The lower pliers body 12 has a second trough 121 with a closed side formed on an upper section thereof corresponding to the first trough 111 of the upper pliers body 11. When the upper pliers body 11 and the lower pliers body 12 are assembled, the first trough 111 and the second trough 121 form a compression trough 13. The compression trough 13 has a retaining rim 131 located on the front end thereof. The retaining rim 131 makes an opening of the compression trough 13 smaller than the outside diameter of the cable connector (not shown in the drawings). The upper pliers body 11 and the lower pliers body 12 have respectively a first notch 112 and a second notch 122 formed on one side of the first trough 111 and the second trough 121. The notches 112 and 122 have openings directed sideward. When the upper pliers body 11 and the lower pliers body 12 are assembled, the first notch 112 and second notch 122 are coupled to form a holding trough 14 to hold the stripping cutter seat 40.

The upper pliers body 11 and the lower pliers body 12 have respectively a first aperture 113 and a second aperture 123 formed on one side in the middle section thereof. When the upper pliers body 11 and the lower pliers body 12 are assembled, the first aperture 113 and the second aperture 123 are coupled to form a pivotal bore 15. The upper pliers body 11 and the lower pliers body 12 further have respectively a first housing chamber 114 and a second housing chamber 124 located in the middle section on another side opposite to the first aperture 113 and the second aperture 123 for housing the sever cutter seat 50. The locations of the first housing chamber 114 and the second housing chamber 124 have respectively a first through opening 115 and a second through opening 125. When the upper pliers body 11 and the lower pliers body 12 are assembled, the openings 115 and 125 are coupled to form a through cutting opening 16. In the first opening 115, there is a retaining flange 1151.

The upper pliers body 11 and the lower pliers body 12 have respectively a lower section to form a first grip section 116 and a second grip section 126. When the upper pliers body 11 and the lower pliers body 12 are assembled, the first grip section 116 and second grip section 126 are coupled to form a handgrip 17. The handgrip 17 has an indented section to form a finger notch 171.

The pliers stem 20 encases a metallic pliers lever 21. The upper sections of the pliers stem 20 and pliers lever 21 have a cable coupling section 23 corresponding to the holding trough 14 of the pliers body 10. The pliers stem 20 and pliers lever 21 further have a pivotal aperture 24 located in the middle section thereof that corresponds to the pivotal bore 15 of the pliers body 10. The pliers lever 21 further has a forcing section 25 extending towards the cutting opening 16 of the pliers body 10. The forcing section 25 has a guiding hole 251 formed on a location corresponding to the compression trough 13 of the pliers body 10. Below the guiding hole 251, there is a hook ring 252. The forcing section 25 on a section corresponding to the cutting opening 16 of the pliers body 10 is ground to form a cutter blade 253. The pliers stem 20 and pliers lever 21 have a lower section to form a handle 26.

The compression head 30 is substantially a cylindrical element, and has a head section 31 and a leg section 32. On the top end of the head section 31 there is a housing opening 311 to receive the center conductive wire (not shown in the drawings) to prevent it from rupturing during compression operations. The head section 31 has a retaining ring 312 adjacent to the top end to press against the metal sleeve (not shown in the drawings) of the cable connector. The leg section 32 is formed in a U shape to straddle the forcing section 25 of the pliers lever 21, and is run through by a pin 70 to engage with the guiding hole 251 of the forcing section 25 to enable the forcing section 25 to drive and move the compression head 30. The forcing section 25 exerts force on the compression head 30 in a biased manner. The guiding hole 251 is formed in an oval shape to give the pin 70 the required moving allowance.

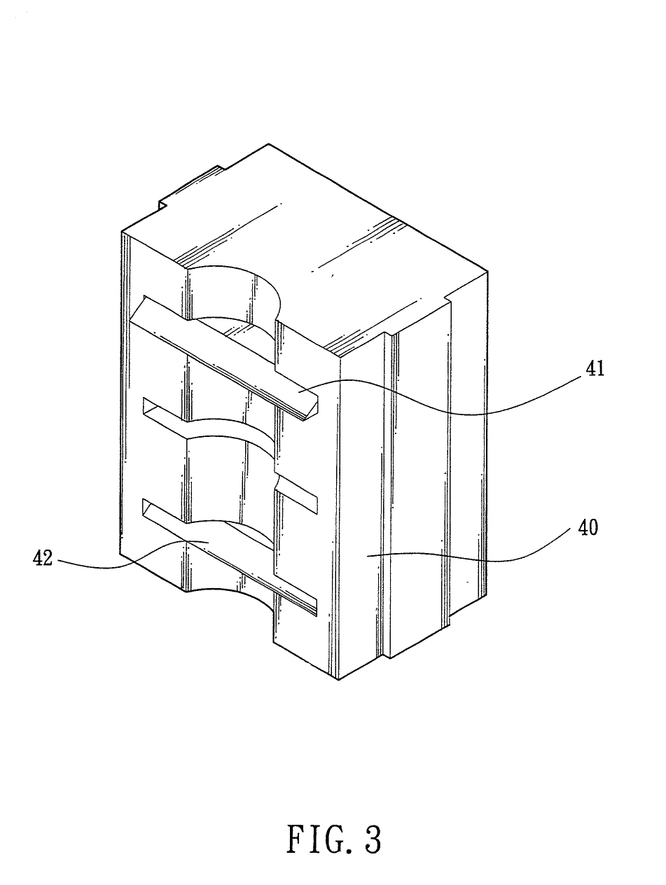

The stripping cutter seat 40 is located in the holding trough 14 of the pliers body 10, and has a first cutter 41 and a second cutter 42 (as shown in FIG. 3) that are spaced from each other. The first cutter 41 is located at a higher elevation than that of the second cutter 42. The first cutter 41 can completely strip the outer insulation layer, metal mesh and inner insulation duct of the coaxial cable while the second cutter 42 can strip only the outer insulation layer of the coaxial cable.

The sever cutter seat 50 is located in the first housing chamber 114 and the second housing chamber 124, and is made of metal and formed in a U shape. The forcing section 25 of the pliers lever 21 runs through the sever cutter seat 50. One side of the forcing section 25 is ground to form a cutter blade 51, which is extended to the cutting opening 16.

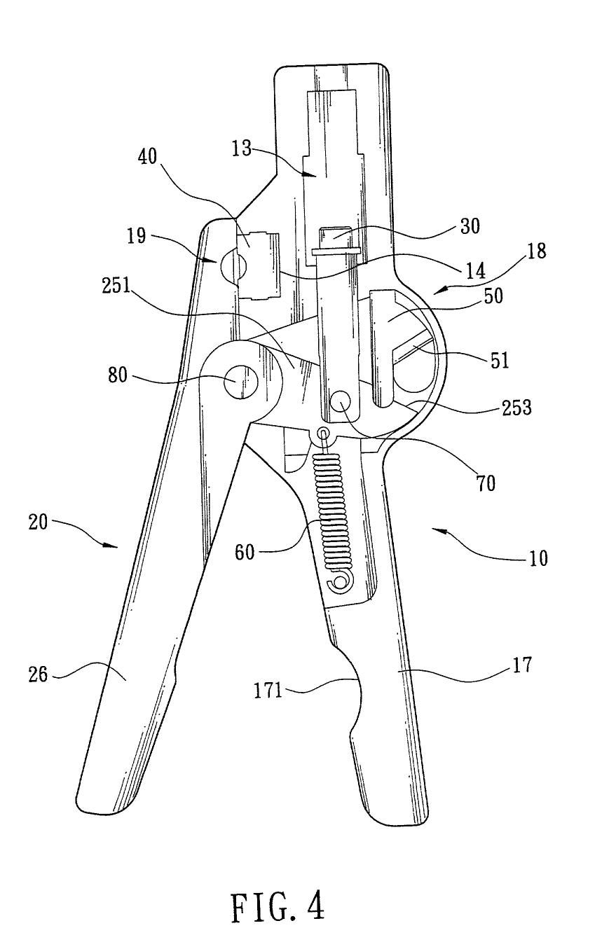

Referring to FIG. 4, the sever cutter seat 50 is located in the first housing chamber 114 and the second housing chamber 124 of the pliers body 10. The compression head 30 is located in the compression trough 13 of the pliers body 10. The forcing section 25 of the pliers lever 21 runs through the leg section 32 of the compression head 30 and the sever cutter seat 50. The pin 70 runs through the guiding hole 251 of the forcing section 25 to enable the pliers stem 20 to drive and move the compression head 30. The elastic element 60 has one end engaging with the handgrip 17 of the pliers body 10. There is an axle 80 running through the pivotal bore 15 of the pliers body 10 and pivotal aperture 24 of the pliers stem 20 so that the pliers stem 20 may be pivotally and movably engaged with the pliers body 10. Because of the elasticity of the elastic element 60, the pliers stem 20 is spaced from the pliers body 10 at a selected distance in a first position, and may be moved and closed to the pliers body 10 by force in a second position.

At the first position, the cutter blade 253 of the forcing section 25 is located below the cutting opening 16 without extending to the cutting opening 16. While moving from the first position to the second position, the cutter blade 253 of the forcing section 25 and the cutter blade 51 of the sever cutter seat 50 are moved towards each other in a cross manner to perform cutting operations. In other words, the cutter blade 253 of the forcing section 25 and the cutter blade 51 of the sever cutter seat 50 form a cutting section 18 to cutoff the coaxial cable and the center conductive wire to a selected length.

The stripping cutter seat 40 is located in the holding trough 14 of the pliers body 10. At the first position, the cable coupling section 23 of the pliers stem 20 contacts the stripping cutter seat 40. At the second position, the cable coupling section 23 of the pliers stem 20 is moved away from the stripping cutter seat 40. Hence the coaxial cable may be placed on the stripping cutter seat 40 in the second position, and may be clamped by the cable coupling section 23 in the first position. Thus the stripping cutter seat 40 and the cable coupling section 23 form a stripping section 19 to perform stripping operations to remove the outer insulation layer and inner insulation duct, and bare the center conductive wire and metal mesh in a stepwise manner.

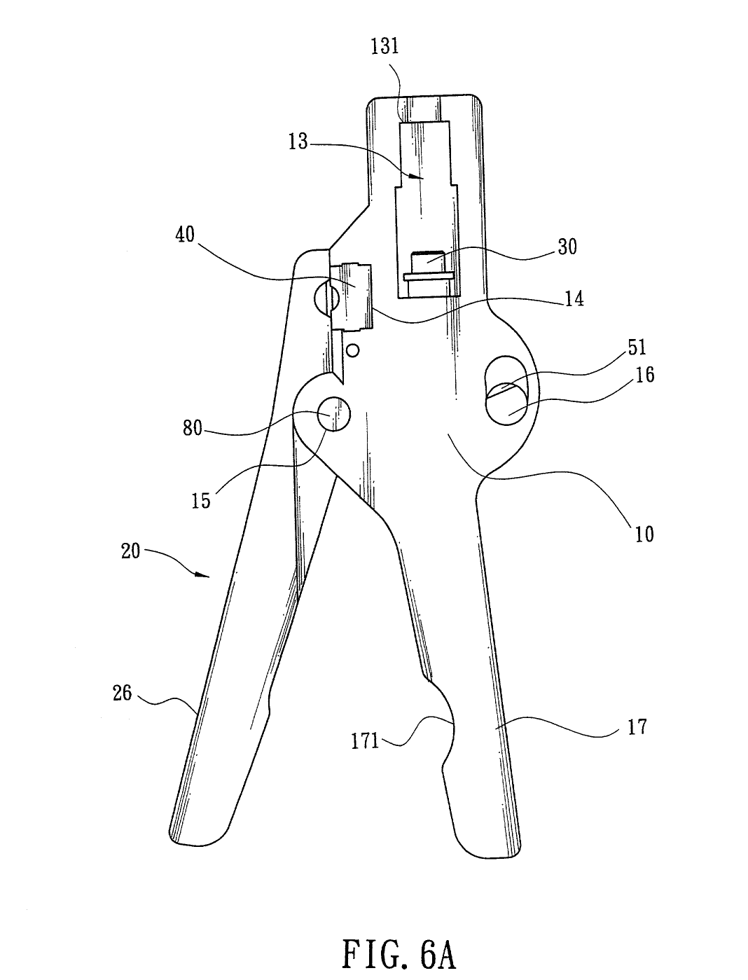

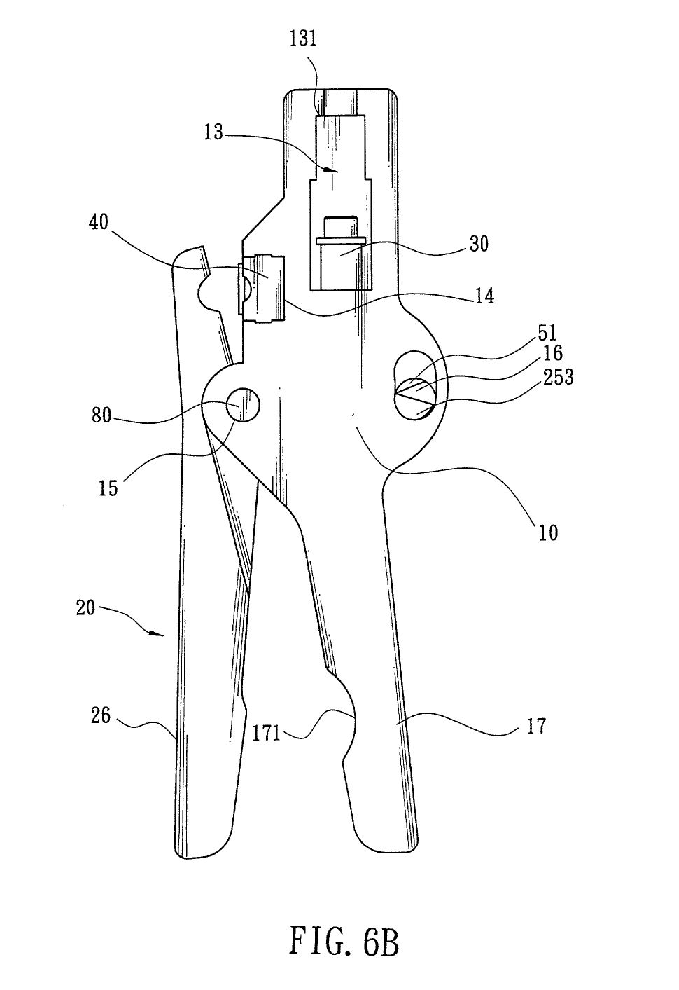

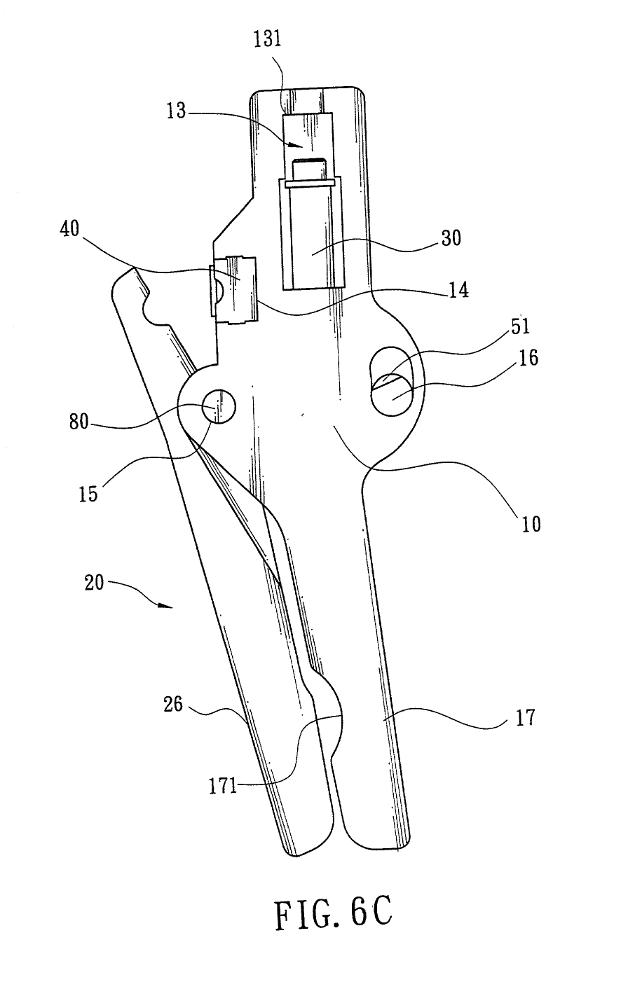

Refer to FIGS. 6A, 6B and 6C for the operating procedures of using the tool of the invention to fasten the coaxial cable to the cable connector.

First, prepare a coaxial cable. In normal conditions, the pliers stem 20 is at the first position, and the cutter blade 253 does not extend to the cutting opening 16. Insert one end of the coaxial cable into the cutting opening 16 of the cutting section 18 and move the coaxial cable to a position until reaching the required length. Grip the handgrip 17 and handle 26. Exert force on the handle 26 to move the pliers stem 20 to the second position. The cutter blade 253 of the forcing section 25 and the cutter blade 51 of the sever cutter seat 50 are moved towards each other in a cross manner to cutoff the coaxial cable.

Then keep the pliers stem 20 in the second position. The cable coupling section 23 of the pliers stem 20 is separated from the stripping cutter seat 40 and the severed end of the coaxial cable is located on the stripping cutter seat 40. Release the force applied on the handle 26. The elastic element 60 pushes the pliers stem 20 to the first position and the cable coupling section 23 clips the coaxial cable. Grasp the coaxial cable with one hand and put the forefinger of the other hand on the finger notch 171 of the handgrip 17 to turn accordingly. The stripping section 19 performs the operation of the next cycle, removes the outer insulation layer and inner insulation duct, and bares the center conductive wire and metal mesh in a stepwise manner.

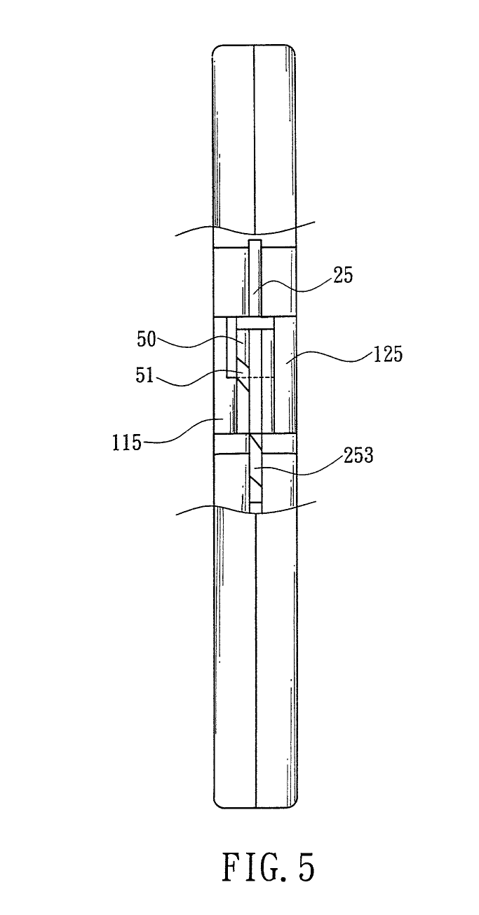

Insert the bared center conductive wire of the coaxial cable into the cutting opening 16, and make the coaxial cable contact the retaining flange 1151. The distance between the retaining flange 1151 and cutter blade 51 is the required length of the center conductive wire (as shown in FIG. 5). Once again, grip the handgrip 17 and handle 26, and exert force on the handle 26 to move the pliers stem 20 from the first position to the second position. The cutter blade 253 of the forcing section 25 and the cutter blade 51 of the sever cutter seat 50 are moved towards each other in a cross manner to cut off the extra portion of the coaxial cable.

When the center conductive wire is cut off, insert one end of the coaxial cable that has the bared center conductive wire and metal mesh into the cable connector in which the metal sleeve and packing ring are still separated. Place the cable connector and coaxial cable together in the compression trough 13, grip the handgrip 17 and handle 26, and exert force on the handle 26 to move the pliers stem 20 from the first position to the second position. On the moving displacement, the pliers stem 20 moves the compression head 30 from an uncompressed position to a compressed position. As the metal sleeve of the cable connector is bucked against the retaining ring 312 of the compression head 30, the packing ring of the cable connector is pressed against the retaining rim 131. Through the thrust of the compression head 30, the packing ring is squeezed into the metal sleeve to complete the fastening operation of the cable connector and coaxial cable.

By means of the construction set forth above, the invention provides a special combination tool for fastening a cable connector and coaxial cable, and is capable of performing all the required functions such as cutting, stripping, and compressing.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A tool for compressing a cable connector to perform cutting and stripping operations on a coaxial cable and to fasten the coaxial cable to the cable connector, comprising:
a pliers body including a compression trough for holding the cable connector, a stripping cutter seat located on one side thereof, a sever cutter seat located therein, and a through cutting opening formed on a location corresponding to the sever cutter seat to allow the coaxial cable to run through;
a pliers stem movably located in the pliers body being engaged with the pliers body through an elastic element, the pliers stem being spaced from the pliers body for a selected distance at a first position in normal conditions, and being movable by force to close to the pliers body at a second position, the pliers stem further having a cable coupling section corresponding to the stripping cutter seat, the cable coupling section and the stripping cutter seat being set to perform stripping operation for the coaxial cable, the stripping cutter seat having a cutter blade to couple with the stripping cutter seat to cutoff the coaxial cable; and
a compression head located in the compression trough and connected to the pliers stem having an uncompression position corresponding to the first position of the pliers stem and being movable to a compression position when the pliers stem is moved to the second position for fastening the coaxial cable to the cable connector.

2. The tool for compressing a cable connector of claim 1, wherein the pliers body includes an upper pliers body and a lower pliers body.

3. The tool for compressing a cable connector of claim 1, wherein the pliers body further has a handgrip which has a finger notch.

4. The tool for compressing a cable connector of claim 1, wherein the cutting opening of the pliers body has a retain flange spaced from the sever cutter seat for a selected distance.

5. The tool for compressing a cable connector of claim 1, wherein the stripping cutter seat has a first cutter and a second cutter spaced from each other for a selected distance and located at different elevations.

6. The tool for compressing a cable connector of claim 1, wherein the sever cutter seat has a cutter blade extending to the cutting opening and movable against the cutter blade of the pliers stem in a cross manner to perform cutting operation.

7. The tool for compressing a cable connector of claim 1, wherein the compression trough has a retain rim which has a diameter smaller than the exterior diameter of the cable connector.

8. The tool for compressing a cable connector of claim 1, wherein the pliers body and the pliers stem have corresponding pivotal apertures to couple with an axle to allow the pliers stem movably and pivotally engaging with the pliers body.

9. The tool for compressing a cable connector of claim 1, wherein the pliers stem further has a pliers lever which has a forcing section, the compression head being straddled over and connecting the forcing section for the pliers stem to drive and move the compression head.

10. The tool for compressing a cable connector of claim 1, wherein the pliers stem further has a handgrip.

11. The tool for compressing a cable connector of claim 1, wherein the compression head has a head section and a leg section, the head section having a housing opening and a retain ring, the leg section being connected to the pliers stem.
